(19) United States
(12) Patent Application Publication
(10) Pub. No.: US 2013/0045069 A1
(43) Pub. Date: Feb. 21, 2013

(54) APPARATUS AND METHOD FOR LOADING AND UNLOADING CARGO

(71) Applicant: John P. Day, Waterford, MS (US)

(72) Inventor: John P. Day, Waterford, MS (US)

(21) Appl. No.: 13/658,776

(22) Filed: Oct. 23, 2012

Related U.S. Application Data
(63) Continuation-in-part of application No. 10/905,232, filed on Dec. 22, 2004, now abandoned.

(51) Int. Cl. B60P 1/43

(52) U.S. Cl. 414/537; 414/812

(57) ABSTRACT

An apparatus and method for securing a ramp to a cargo carrier having a receiver hitch and a loading surface are disclosed. The apparatus includes an engaging member configured to engage the receiver hitch of the cargo carrier; a cross support attached to the engaging member, wherein the cross support has a plurality of mounting brackets mounted thereto; at least two locking members attached to the cross support and on opposite sides of the engaging member extend vertically therefrom, wherein each locking member slideably receives a locking pin; and a plurality of telescopic arms attaching the ramp to the mounting brackets, wherein each telescopic arm has an inner portion and an outer portion, wherein the outer portion and inner portion have at least one set of apertures for slideably receiving a locking pin.

This application is a continuation-in-part of U.S. patent application Ser. No. 10/905,232 filed on Dec. 22, 2004 entitled “Apparatus and Method For Loading and Unloading Cargo” herein incorporated by reference.

### DESCRIPTION

1. Field of the Invention

This invention relates to an apparatus for securing a ramp to a cargo carrier, such as a moving vehicle or trailer.

2. Background of the Invention

Since the need to transport cargo, there has been a need for a ramp to load and unload the cargo transported in cargo carriers, such as moving vehicles or trailers. In the past, one common method of securing a loading ramp to a pickup truck to load or unload cargo comprises placing one end of a conventional ramp on the ground and the other end to the loading surface, which is typical,+the topside portion of an opened tailgate of a truck or sports utility vehicle/Such conventional ramps are attached to the loading surface by chains, cables or other means of attachment.

These means of attachment do not safely secure the ramps to the loading surface of a cargo carrier. Upon use, the ramps are prone to accidental slippage thereby causing injury to the user of such ramps and to the cargo being loaded or unloaded.

Additionally, these means of attachment do not allow for the ramps to remain outside of the moving vehicle during transport of the cargo. Before transport, the ramps must be unattached from the loading surface and placed into the truck bed. It is common for unattached ramps to be stolen from truck beds when such ramps are not in use.

### BRIEF SUMMARY OF THE INVENTION

The present invention discloses an apparatus that securely positions ramps to the loading surface of a cargo carrier, such as truck or sports utility vehicle, allowing the cargo to be safely loaded or unloaded.

The present invention discloses an apparatus that securely positions ramps to the loading surface of a cargo carrier thereby reducing the number of injuries to persons and cargo caused by accidental ramp slippage.

The present invention discloses an apparatus having ramps attached thereto which reduces the likelihood of theft of the ramps when such ramps are not in use.

The present invention discloses-an apparatus that prevents the theft of equipment, all terrain vehicles, rideable work vehicles, such as lawnmowers, motorcycles, snowmobiles, etc. carried in the truck bed of a pickup truck or in a trailer when the apparatus is in the transport position because the apparatus prevents the tailgate of the pickup truck or trailer from being opened.

The present invention discloses an apparatus for securing a ramp to a cargo carrier having a receiver hitch and a loading surface. The apparatus is made of (a) an engaging member configured to engage the receiver hitch of the cargo carrier; (b) a cross support attached to the engaging member, wherein the cross support has a plurality of mounting brackets mounted thereto; (c) at least two locking members, wherein the locking members are attached to opposite ends of the cross support and extend vertically therefrom, wherein each locking member has an aperture configured to slideably receive a ramp locking pin; and (d) a plurality of telescopic arms attached to the mounting brackets, wherein each telescopic arm has an inner portion and an outer portion, wherein the inner portion is configured to attach to at least one ramp.

In the preferred embodiment, the loading surface is a tailgate of a moving vehicle. In another embodiment, the loading surface is a trailer.

In the preferred embodiment, the ramp has at least one set of apertures configured to slideably receive a ramp locking pin.

In the preferred embodiment, the cross support has two plates. The plates are attached to opposite ends of the cross support. Each plate is configured to attach to one locking member.

In the preferred embodiment, the mounting brackets are adjustable.

In the preferred embodiment, the inner portion of each telescopic arm has at least one set of apertures for slideably receiving a ramp locking pin. The outer portion of each telescopic arm has at least one set of apertures for slideably receiving a ramp locking pin.

In the preferred embodiment, the apparatus is made of metal.

The present invention further discloses a method for loading/unloading cargo from a cargo carrier utilizing an apparatus for securing a ramp to a cargo carrier having a receiver hitch and a loading surface, wherein the apparatus comprises: (1) an engaging member configured to engage the receiver hitch of the cargo carrier, (2) a cross support attached to the engaging member, wherein the cross support has a plurality of mounting brackets mounted thereto, (3) at least two locking members, wherein said locking members are attached to opposite ends of the cross support and extend vertically therefrom, wherein each locking member has an aperture configured to slideably receive a ramp locking pin, and (4) a plurality of telescopic arms attached to said plurality of mounting brackets, wherein each said telescopic arm has an outer portion and an inner portion, wherein said outer portion has at least one set of apertures for slideably receiving a ramp locking pin, wherein said inner portion has at least one set of apertures for slideably receiving a ramp locking pin, wherein the inner portion is configured to attach to at least one ramp, wherein the ramp has at least one set of apertures configured to slideably receive a ramp locking pin, the method comprising: (a) assembling the apparatus (b) attaching the engaging member of the apparatus to the receiver hitch of the cargo carrier; (c) attaching at least one ramp to at least two of the plurality of telescopic arms; (d) positioning the top of the at least one ramp to the loading surface of the cargo carrier; and (e) securing at least one ramp locking pin through at least two telescopic arms.

In the preferred method, the loading surface of the cargo carrier is a tailgate of a moving vehicle or a trailer.

In the preferred method, the cross support has two plates. The plates are attached to opposite ends of the cross support. Each plate is configured to attach to one locking member.

The present invention further discloses a method for loading/unloading cargo from a cargo carrier utilizing an apparatus for securing a ramp to a cargo carrier having a receiver hitch and a loading surface, wherein the apparatus comprises: (1) an engaging member configured to engage the receiver hitch of the cargo carrier, (2) a cross support attached to the engaging member, wherein the cross support has a plurality of mounting brackets mounted thereto, (3) at least two locking members, wherein said locking members are attached to opposite ends of the cross support and extend vertically therefrom, wherein each locking member has an aperture configured to slideably receive a ramp locking pin, and (4) a plurality of telescopic arms attached to said plurality of mounting brackets, wherein each said telescopic arm has an outer portion and an inner portion, wherein said outer portion has at least one set of apertures for slideably receiving a ramp locking pin, wherein said inner portion has at least one set of apertures for slideably receiving a ramp locking pin, wherein the inner portion is attached to at least one ramp, wherein the ramp has at least one set of apertures configured to slideably receive a ramp locking pin, the method comprising: (a) attaching the engaging member of the apparatus to the receiver hitch of the cargo carrier; (b) removing the ramp locking pin; (c) lowering the ramps; (d) positioning the top of the at least one ramp to the loading surface of the cargo carrier; and (e) securing at least one ramp locking pin through at least two telescopic arms.

In the preferred embodiment, the loading surface of the cargo carrier is a tailgate of a moving vehicle or a trailer.

In the preferred method, the cross support has two plates. The plates are attached to opposite ends of the cross support. Each plate is configured to attach to one locking member.

### BRIEF DESCRIPTION OF THE DRAWINGS

FIG. 1 is a side view of the apparatus attached to the receiver hitch of a moving vehicle with the ramp in the load/unload position.

FIG. 2 is a perspective view of the apparatus for loading or unloading cargo.

FIG. 3A is an exploded view of the engaging member, cross support, and locking members.

FIG. 3B is an exploded view of a telescopic arm.

FIG. 4 is a front view of the apparatus attached to the receiver hitch of a moving vehicle wherein the apparatus is in the transport position.

FIG. 5 is a side view of the apparatus attached to the receiver hitch of a moving vehicle wherein the apparatus is in the transport position.

FIG. 6A is a side view of the apparatus attached to the receiver hitch of a moving vehicle with the ramp resting on the cross support.

FIG. 6B is a side view of the apparatus attached to the receiver hitch of a moving vehicle with the tailgate opened and with the ramp moving toward the loading surface.

FIG. 6C is a side view of the apparatus attached to the receiver hitch of a moving vehicle with the ramp in the load/unload position.

FIG. 7 is a side view of a second embodiment of the apparatus attached to the receiver hitch of a moving vehicle with the ramp in the load/unload position.

FIG. 8 is a perspective view of the second embodiment of the apparatus for loading or unloading cargo.

FIG. 9A is an exploded view of the second embodiment of the engaging member, cross support, mounting bracket, and locking member.

FIG. 9B is an exploded view of the second embodiment of a telescopic arm.

FIG. 10A is a front view of the second embodiment of the apparatus attached to the receiver hitch of a moving vehicle wherein the apparatus is in the transport position, the ramp positioned wide on the cross support.

FIG. 10B is a front view of the second embodiment of the apparatus attached to the receiver hitch of a moving vehicle wherein the apparatus is in the transport position, the ramp positioned together on the cross support.

FIG. 11 is a side view of the second embodiment of the apparatus attached to the receiver hitch of a moving vehicle wherein the apparatus is in the transport position.

FIG. 12A is a side view of the second embodiment of the apparatus attached to the receiver hitch of a moving vehicle with the ramp resting on the cross support.

FIG. 12B is a side view of the second embodiment of the apparatus attached to the receiver hitch of a moving vehicle with the tailgate opened and with the ramp moving toward the loading surface.

FIG. 12C is a side view of the second embodiment of the apparatus attached to the receiver hitch of a moving vehicle with the ramp in the load/unload position.

### DETAILED DESCRIPTION OF THE INVENTION

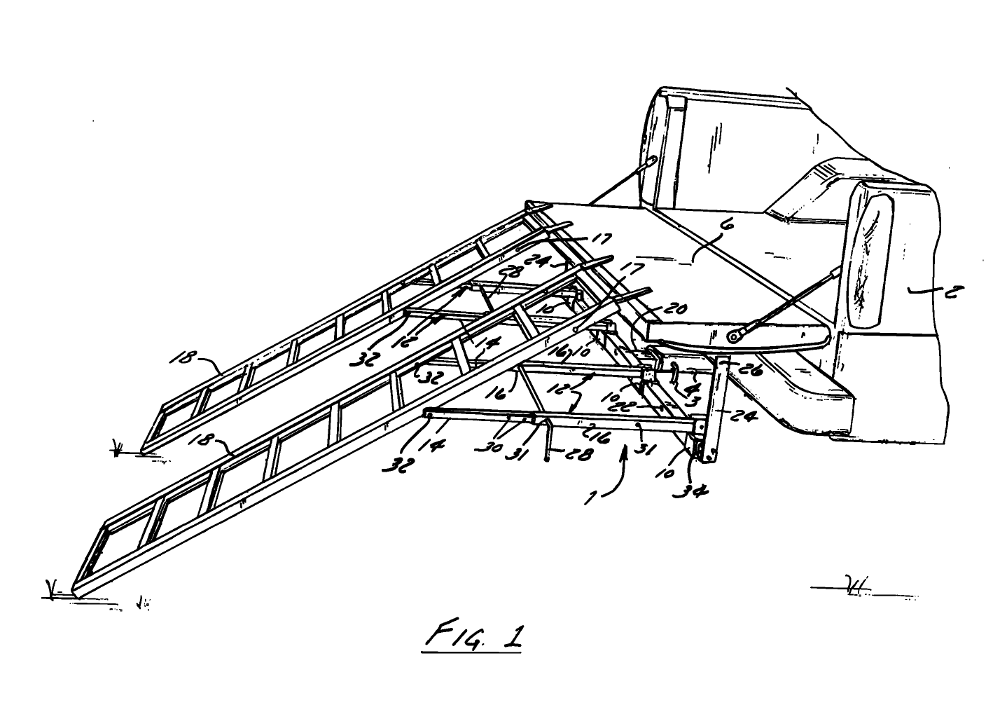

Referring now to FIG. 1, the present invention discloses an apparatus 1 for securing a ramp 18 to a cargo carrier 2.

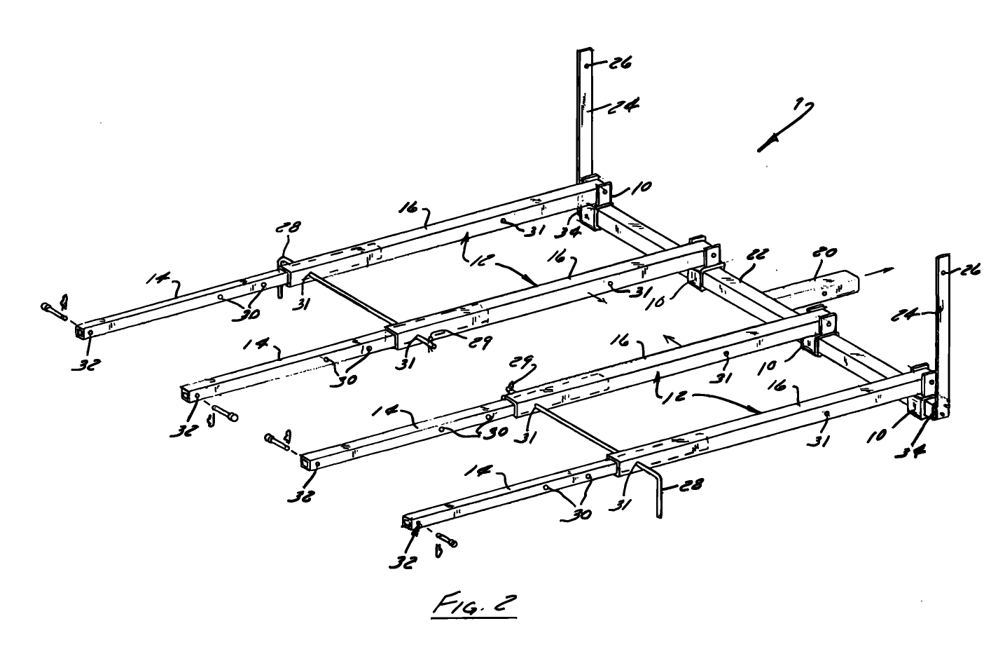

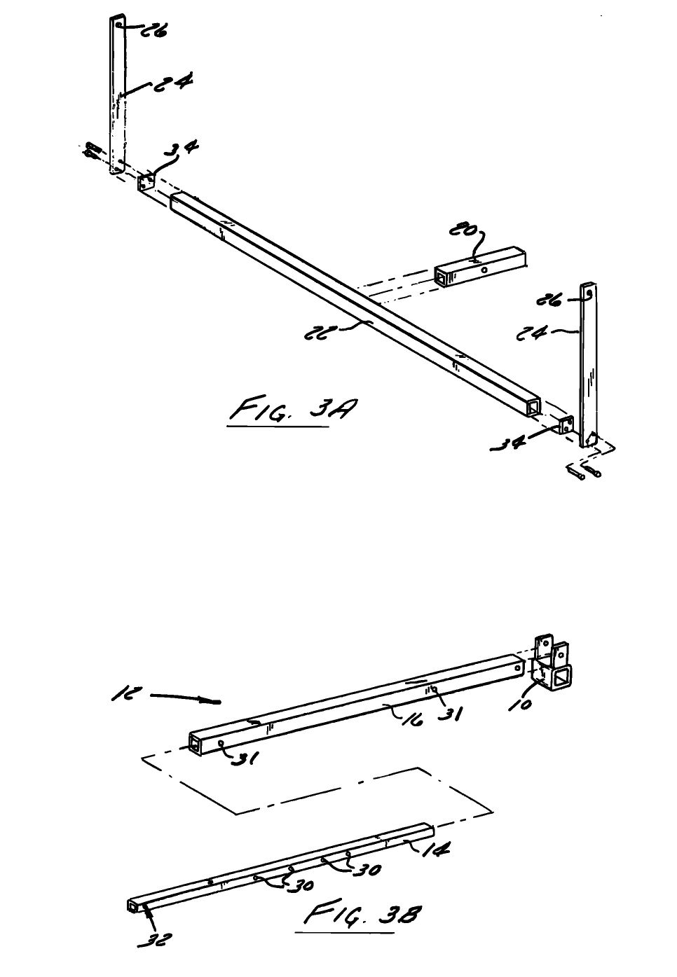

Now referring to FIGS. 1-2, the apparatus 1 is made of an engaging member 20, cross support 22, at least two locking members 24, and a plurality of telescopic arms 12. The engaging member 20 is configured to engage the receiver hitch 4 which is permanently attached to cargo carrier 2. The cross support 22 is preferably attached perpendicularly to the engaging member 20 by welding but other means of attachment may be used as desired by one of skill in the art (see FIG. 3A). Locking members 24 extend vertically from cross support 22 (see FIG. 3A).

Cross support 22 has a plurality of mounting brackets 10 mounted thereto. Mounting brackets 10 are hollow and slide onto cross support 22 before locking members 24 are attached to cross support 22. Mounting brackets 10 are adjustable across the length of cross support 22 to accommodate widths of varying ramps 18. In the preferred embodiment, four mounting brackets 10 are mounted to cross support 22. More or less than four mounting brackets 10 may be used depending on the size and number of ramps 18 used as desired by one of skill in the art. Two mounting brackets 10 are needed for each ramp 18 used. The width between mounting brackets 10 will vary depending on the widths of the ramps 18. In the preferred embodiment, four mounting brackets 10 are about eleven inches apart in order to accommodate a two ramp system where each ramp 18 is about eleven inches wide.

In the preferred embodiment, the cross support 22 has two plates 34. The plates 34 are preferably welded to opposite ends of the cross support 22, but other means of attachment may be used as desired by one of skill in the art. Each plate 34 is configured to attach to one locking member 24 by two bolts, but other means of attachment may be used as desired by one of skill in the art. In another embodiment, locking members 24 are attached to cross support 22 by other means, such as welding, as desired by one of skill in the art.

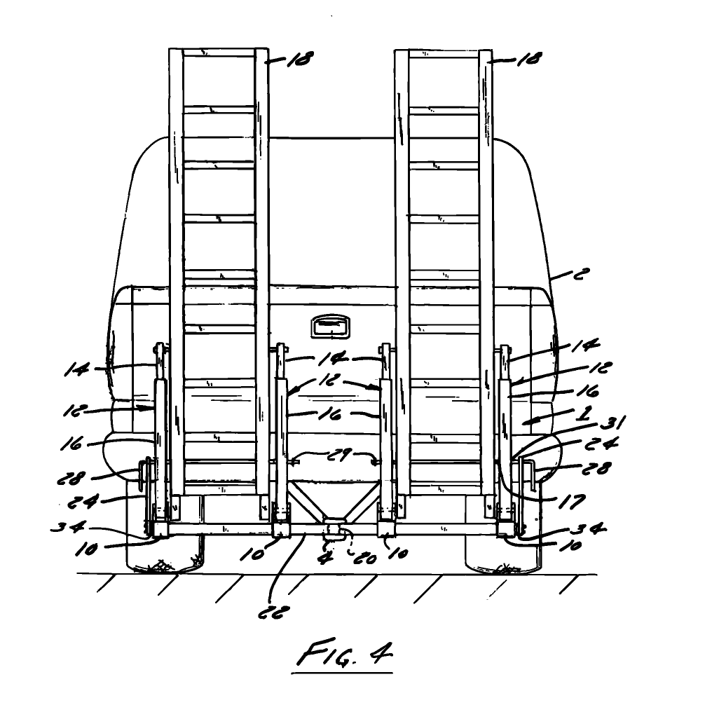

In the preferred embodiment, locking members 24 are attached to plate 34 located at opposite ends of the cross support 22. Locking members extend vertically from cross support 22. Each locking member 24 has an aperture 26 configured to slideably receive a ramp locking pin 28 when the apparatus 1 is in the transport position. (see FIG. 4).

In the preferred embodiment, four telescopic arms 12 are attached to the mounting brackets 10. More or less than four telescopic arms 12 may be used depending on the size and number of ramps 18 used as desired by one of skill in the art. Telescopic arms 12 pivot from a transport position (see FIG. 4) to a load/unload position (see FIG. 1). Each telescopic arm 12 has an inner portion 14 and an outer portion 16. An end portion 32 of inner portion 14 is configured to attach to ramp 18. In the preferred embodiment, at least one ramp 18 is attached to end portion 32 of inner portion 14 of at least two telescopic arms 12 by a bolt but other means of attachment may be used as desired by one of skill in the art. Inner portion 14 has at least one set of apertures 30 for slideably receiving a ramp locking pin 28 both in the transport and load/unload position. Outer portion 16 has at least one set of apertures 31 for slideably receiving a ramp locking pin 28 both in the transport and load/unload positions.

Referring now to FIG. 3B, in a preferred embodiment, inner portion 14 of telescopic arm 12 has multiple sets of apertures 30 configured to slideably receive a ramp locking pin 28 both in the transport and load/unload positions. Outer portion 16 has two sets of apertures 31 for slideably receiving a ramp locking pin 28 both in the transport and load/unload positions. In the transport and load/unload positions, one set of apertures 31 of outer portion 16 aligns with one set of apertures 30 of inner portion 14 and the ramp locking pin 28 is inserted into both sets of apertures to secure ramp 18. The length of telescopic arm 12 can be adjusted as needed by the user of the invention by adjusting the length of inner portion 14 and aligning one set of apertures 30 of inner portion 14 with set of apertures 31 of outer portion 16 and inserting ramp locking pin 28.

In the preferred embodiment, apparatus 1 is made of metal, particularly steel, but other materials may be used as desired by one of skill in the art.

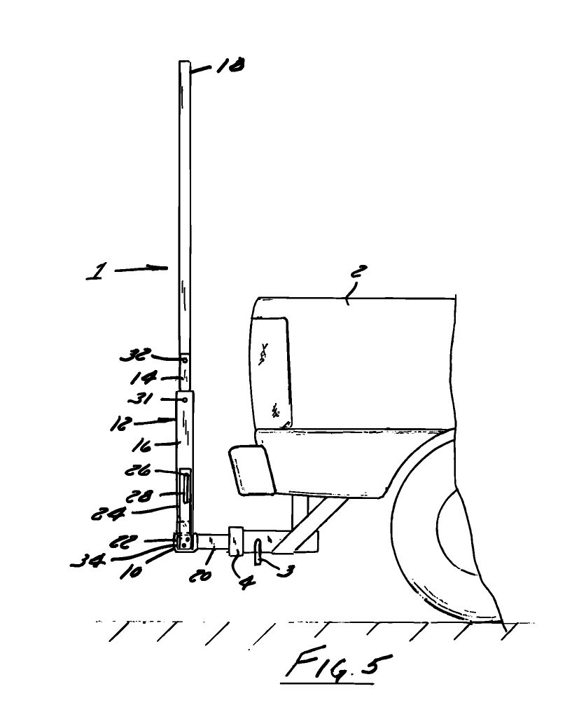

Referring now to FIGS. 4-5, apparatus 1 is in the transport position. In the preferred embodiment, apparatus 1 secures two ramps 18 to cargo carrier 2. Cargo carrier 2 is anything that transports cargo, such as a truck, sports utility vehicle or trailer. Cargo carrier 2 has a receiver hitch 4 and a loading surface 6 (see FIG. 1). Apparatus 1 is attached to the receiver hitch 4 of cargo carrier 2. Engaging member 20 is inserted into the receiver hitch 4 of cargo carrier 2 and connected to the receiver hitch 4 by a hitch pin 3. Two ramps 18 are pivotably attached to end portion 32 of inner portion 14 of telescopic arms 12. Telescopic arms 12 are parallel to the cargo carrier 2 in the transport position. Telescopic arms 12 and ramps 18 are secured in the transport position by inserting ramp locking pin 28 through apertures 26 of locking members 24, set of apertures 31 of outer portion 16, set of apertures 30 of inner portion 14 and apertures 17 of ramps 18.

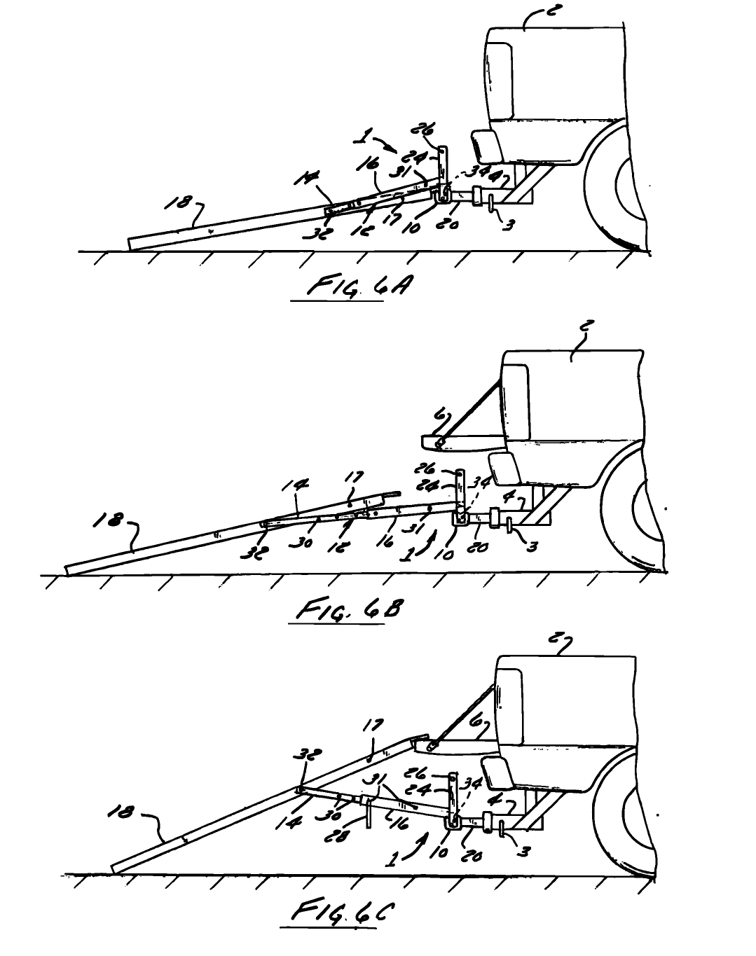

Now referring to FIG. 6A, to secure the ramps in the load/unload position, ramp locking pins 28 are removed and the ramps 18 are initially lowered to rest on the cross support 22. When standing on the passenger's side of cargo carrier 2, as ramps 18 are lowered, the ramps 18 rotate counterclockwise from the transport position to the load/unload position. As ramps 18 are lowered, telescopic arms 12 are lowered because telescopic arms 12 are attached to ramps 18 at end portion 32.

Now referring to FIG. 6B, once ramps 18 are resting on cross support 22, the loading surface 6 is lowered. The loading surface 6 is typically a tailgate of a truck or sports utility vehicle but other loading surfaces 6, such as a trailer, may be used as desired by one of skill in the art. Inner portions 14 of telescopic arms 12 are extended from outer portion 16 so that ramp 18 can be positioned onto loading surface 6.

Now referring to FIGS. 1 and 6C, apparatus 1 is secured to loading surface 6 in the load/unload position. Ramps 18 are securely positioned on loading surface 6 by placing ramp 18 on loading surface 6 and by inserting ramp locking pin 28 through set of apertures 31 of outer portion 16 and set of apertures 30 of inner portion 14 of one telescopic arm 12 and through set of apertures 31 of outer portion 16 and set of apertures 30 of inner portion 14 of another telescopic arm 12 and securing the ramp locking pin 28 with a hair pin fastener 29.

In the preferred embodiment, apparatus 1 has four telescopic arms 12 and two ramps 18. End portions 32 of two telescopic arms 12 are attached to one ramp 18_{—} In the preferred embodiment, two foldable ramps 18 are used. Such ramps 18 are approximately eleven inches in width and six feet in length. Because mounting brackets 10 are adjustable, apparatus 1 can be used with other size and number of ramps 18 as desired by one of skill in the art including two solid ramps, one foldable ramp, one solid ramp, one continuous width ramp which is typically fifty-eight inches in width and has varying lengths, including six and seven feet, foldable by-fold ramps and solid by-fold ramps. A foldable ramp is one that folds lengthways by hinges. A solid ramp does not fold. The mounting brackets 10 are adjustable across the length of cross support 22 to accommodate the widths of the various ramps 18.

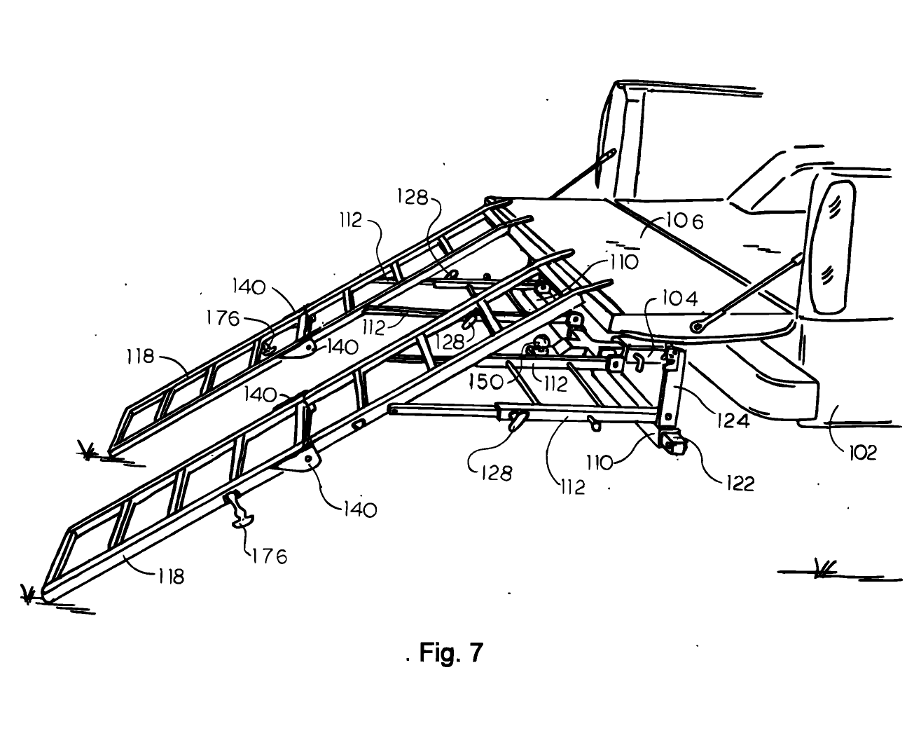

FIG. 7 shows a second embodiment of the invention in a loading/unloading position, wherein locking member 124 are attached to mounting brackets 110. This enables the ramps 118 to be positioned by a user to a desired position along the length of the cross support bar 122 whether the ramps 118 are in a loaded/unloading position or in a stowed position. In this embodiment, each ramp 118 may possess a hinge 140 allowing the ramp 118 to fold compactly for transportation. The bottom end of the ramp 118 rests upon the ground while the top end of the ramp 118 is configured to engage the edge of the loading surface 106. Telescopic arms 112 retain the top end of the ramp 118 against the edge of the loading surface 106. Each telescopic arm 112 is prevented from extending by a spring loaded t-handle pull pin 128. The spring loaded t-handle pull pin 128 ensures the user does not misplace a locking pin. The spring loaded t-handle pull pins may be of a locking variety, able to be locked in an open position, for instance, by rotating the handle. Use of a lockout t-handle spring-loaded pull pin allows the user to easily extend and contract the telescopic arms 112 to the desired position, then release the pull pin 128 locking the telescopic arm 112 in place. This embodiment also possesses a trailer hitch receiver ball 150 allowing the user to pull a trailer while the device is attached to the receiver hitch 104 of the vehicle 102.

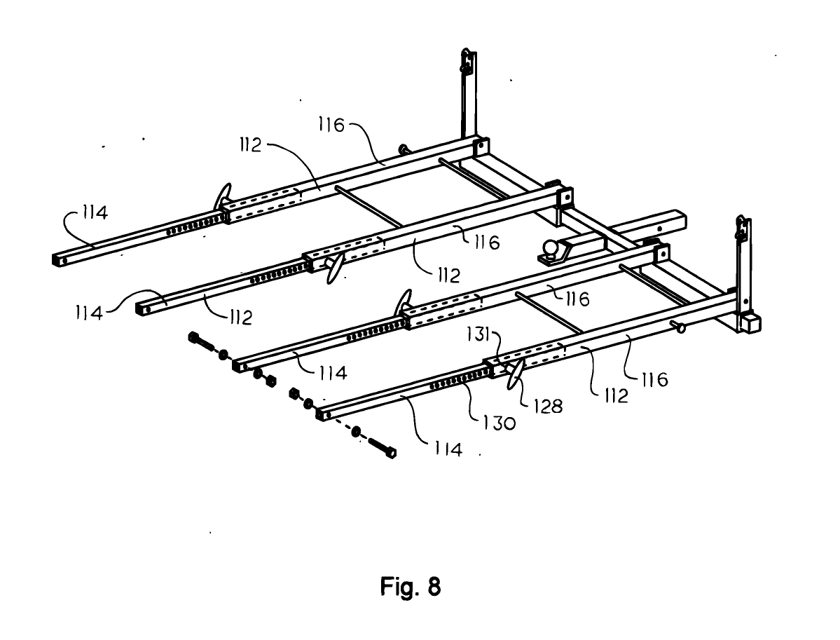

FIG. 8 shows a perspective view of the apparatus for unloading or loading cargo. The telescopic arms 112 possess an inner portion 114 and an outer portion 116. The inner portion 114 possess a plurality of apertures 130. The locking pin 128 passes through an aperture 131 on the outer portion 116 and into an aperture 130 of the inner portion, locking the outer portion 116 relative to the inner portion 114 preventing translation of the telescopic arms 112.

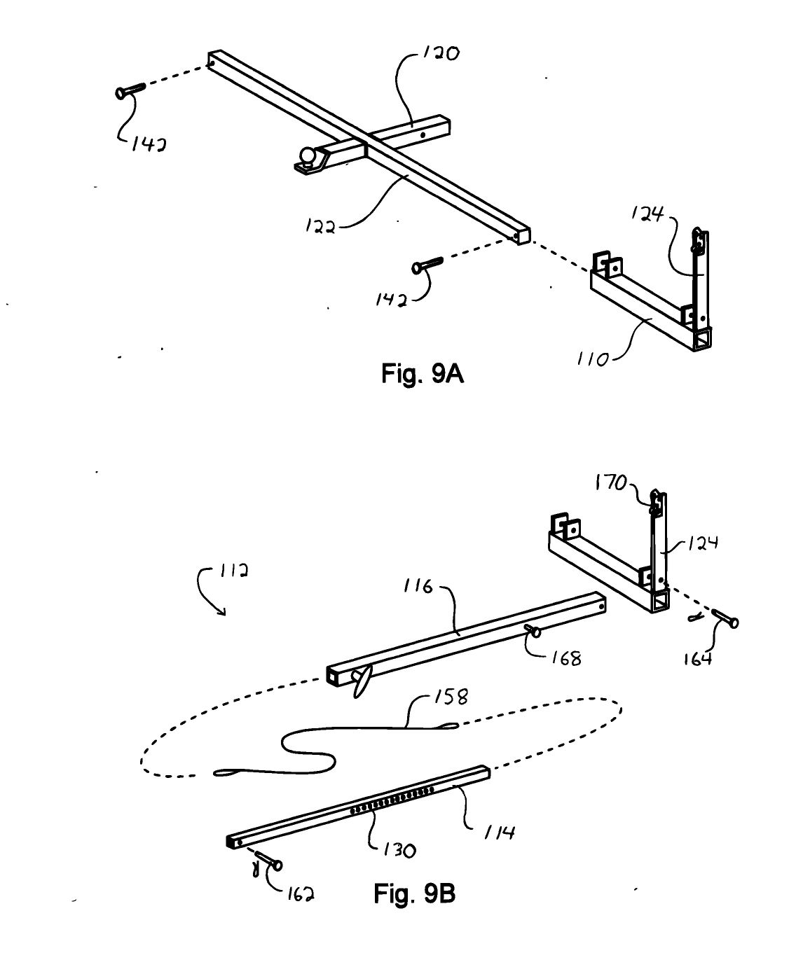

FIG. 9A is an exploded view of the engaging member 120, cross support 122, mounting bracket 110 and locking member 124. The mounting bracket 110 is hollow allowing it to slide along the cross support 122. Retainers 142, such as bolts or pins, prevent the mounting bracket from sliding past the end of the cross support 122.

FIG. 9B is an exploded view of a telescopic arm 112. Inner portion 114 nests within outer portion 116 of the telescopic arm. The plurality of apertures 130 in the inner portion allows the user to lock the telescopic arm at a desired length. A locking pin 168 is configured to slideably engage a self locking latch 170 allowing the telescopic arm 112 to be held in a vertical position by the locking member 124. One end of a lanyard 158 is attached the inner portion 114 by a retainer 162, and the other end of the lanyard 158 is attached to the outer portion 116 by a second retainer 164. The lanyard 158 prevents over extension of the telescopic arm 112. The lanyard 158 also deters theft or vandalism of the apparatus by preventing complete disassembly of the apparatus 1 by separation of the telescopic arms 112.

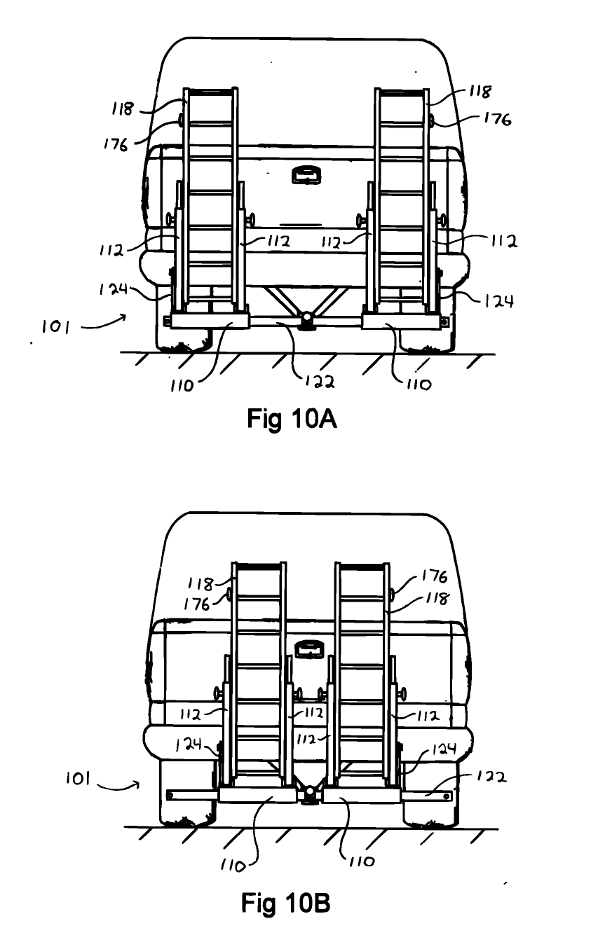

FIG. 10A shows a front view of the apparatus 101 in the stored position ready for transportation. Each half of the ramps 118 are prevented from rotating apart by latches 176. Preferably the latch 176 would be a rubber elastic latch, such as found used for vehicle hood latches. Mounting brackets 110 positionable along the length of the cross support 122 allow the ramps 118 to be positioned at the ends of the cross support as shown.

FIG. 10B shows a front view of the second embodiment of the apparatus 101 in the stored position ready for transportation. Here, the mounting brackets 110 are positioned close to the center of the cross support 122. The locking members 124 attached to the mounting brackets 110 allow the ramps to be secured for transportation in any desired lateral position along the cross support 122.

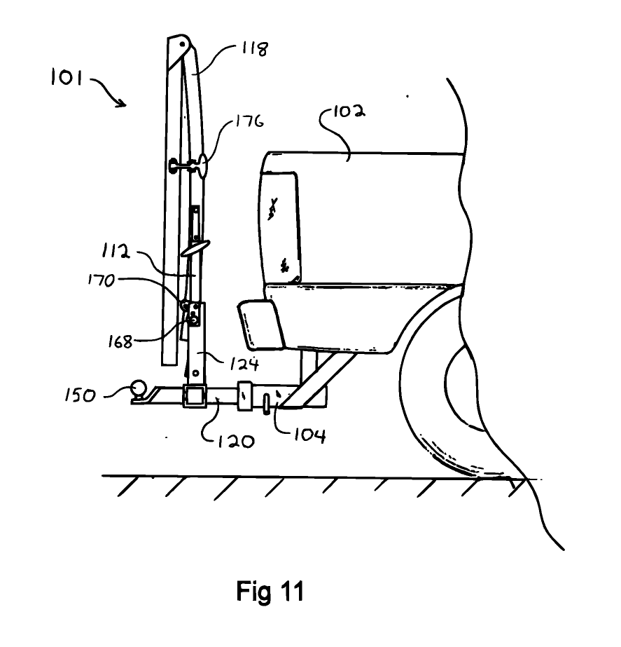

FIG. 11 shows a side view of the invention in a vertical position ready for transportation. The telescopic arms 112 are held in place by the self locking latches 170 engaging locking pins 168. Elastic latches 176 secure the lower portion of the ramp 118 to the upper portion. Presence of a trailer hitch receiver ball 150 allows the user to use pull a trailer with the vehicle 102 while the invention 101 is attached.

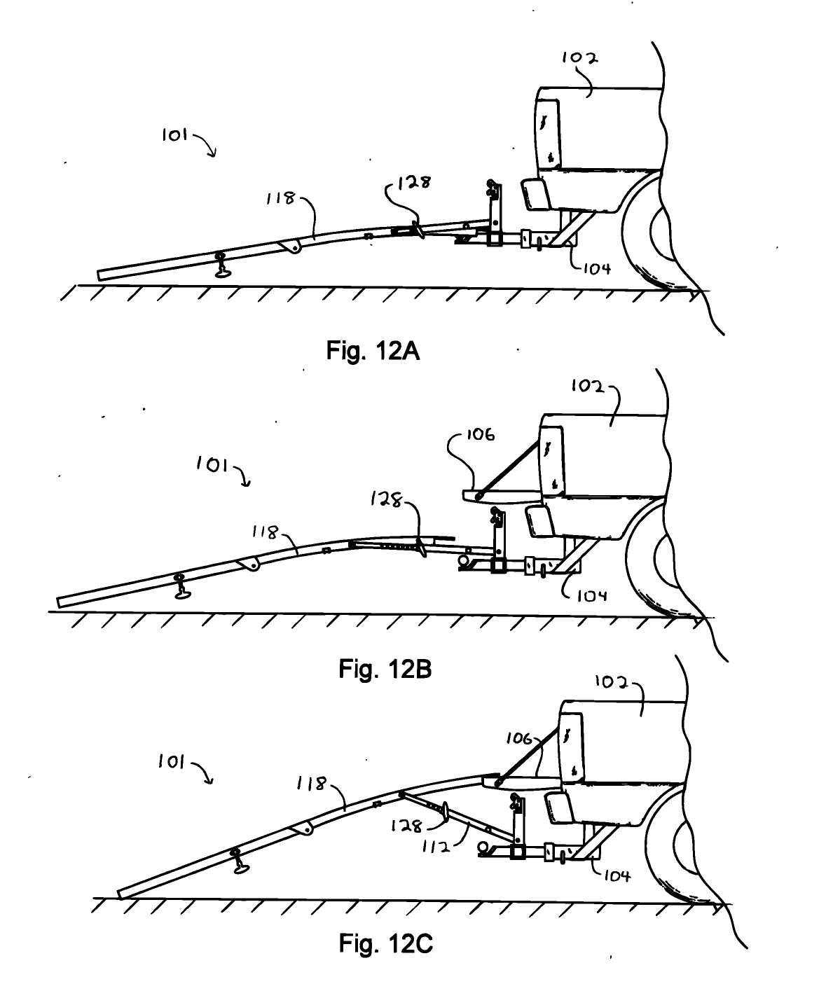

FIG. 12A shows the invention in a partially lowered position, the ramp 118, resting on the cross support 122. The user would then pull and lock the t-handled spring loaded pull pins 128 to prepare for telescopic arms 112 extension.

FIG. 12B shows the invention in a partially lowered state with the telescopic arms 112 extended. The user would raise the upper end of the ramp 118 to the edge of the loading surface 106.

FIG. 12C shows the invention 101 in a loading/unloading position, ready for use. The telescopic arms 112 are locked in position by releasing the spring loaded pull pins 128. The ramps 118 are prevented from slipping off the loading surface 106 by the now locked telescopic arms 112. The telescopic arms 112 also serve to share the load placed on the ramps by transferring a portion of the load to the receiver hitch 104 of the vehicle 102, providing a more stable loading ramp than one merely resting on the loading surface or secured in some other fashion.

Although the foregoing invention has been described in some detail by way of illustration and example for purposes of clarity of understanding, it will be obvious that certain changes and modifications can be made which are within the full scope of the invention.

What is claimed is:

1. A method for loading/unloading cargo from a cargo carrier utilizing an apparatus for securing a ramp to a cargo carrier having a receiver hitch and a loading surface, wherein said apparatus comprises (1) an engaging member configured to engage the receiver hitch of the cargo carrier, (2) a cross support attached to said engaging member, wherein said cross support has a plurality of adjustable mounting brackets mounted thereto, (3) at least two locking members, wherein said locking members are attached to opposite ends of said cross support and extend vertically therefrom, wherein each locking member has an aperture configured to slideably receive a ramp locking pin, and (4) a plurality of telescopic arms attached to said plurality of mounting brackets, wherein each said telescopic arm has an outer portion and an inner portion, wherein said outer portion has at least one set of apertures for slideably receiving a ramp locking pin, wherein said inner portion has at least one set of apertures for slideably receiving a ramp locking pin, wherein the inner portion is configured to attach to at least one ramp, wherein said ramp has at least one set of apertures for slideably receiving a ramp locking pin, said method comprising: (a) assembling the apparatus; (b) attaching the engaging member of said apparatus to the receiver hitch of said cargo carrier; (c) attaching at least one ramp to at least two of the plurality of telescopic arms; (d) positioning the top of the at least one ramp to the loading surface of the cargo carrier; and (e) securing at least one ramp locking pin through two telescopic arms.

2. The method of claim 1 wherein said loading surface is a tailgate of a vehicle.

3. The method of claim 1 wherein said cross support has two plates, wherein said plates are attached to opposite ends of the cross support, wherein each said plate is configured to attach to one locking member.

4. A method for loading/unloading cargo from a cargo carrier utilizing an apparatus for securing a ramp to a cargo carrier having a receiver hitch and a loading surface, wherein said apparatus comprises (1) an engaging member configured to engage the receiver hitch of the cargo carrier, (2) a cross support attached to said engaging member, wherein said cross support has a plurality of adjustable mounting brackets mounted thereto, (3) at least two locking members, wherein said locking members are attached to opposite ends of said cross support and extend vertically therefrom, wherein each locking member has an aperture configured to slideably receive a ramp locking pin, and (4) a plurality of telescopic arms attached to said plurality of mounting brackets, wherein each said telescopic arm has an outer portion and an inner portion, wherein the outer portion has at least one set of apertures for slideably receiving a ramp locking pin, wherein the inner portion has at least one set of apertures for slideably receiving a ramp locking pin, wherein the inner portion is attached to at least one ramp, wherein said ramp has at least one set of apertures for slideably receiving a ramp locking pin, said method comprising: (a) attaching the engaging member of said apparatus to the receiver hitch of said cargo carrier; (b) removing the ramp locking pin; (c) lowering the ramps; (d) positioning the top of the at least one ramp to the loading surface of the cargo carrier; and (e) inserting ramp locking pin into the telescopic arms.

5. The method of claim 4 wherein said loading surface is a tailgate of a vehicle.

6. The method of claim 4 wherein said cross support has two plates, wherein said plates are attached to opposite ends of the cross support, wherein each said plate is configured to attach to one locking member.

7. An apparatus for securing a ramp to a cargo carrier having a receiver hitch and a loading surface, said loading surface having an edge proximal to said ramp, said ramp having a top end, said top end of said ramp configured to engage a said edge of said loading surface, wherein said apparatus comprises: (a) an engaging member configured to engage the receiver hitch of the cargo carrier; (b) a cross support attached to said engaging member, wherein said cross support has a plurality of mounting brackets mounted thereto; (c) at least two locking members, wherein said locking members are mounted to said cross support on opposite sides of said engaging member, said locking members extending vertically from said cross support, wherein each locking member is configured to receive a ramp locking pin; and (d) a plurality of telescopic arms having a first end and a second end, said first end attached to at least one said mounting brackets, wherein each said telescopic arm has an inner portion and an outer portion, wherein the outer portion has at least one aperture for slideably receiving a ramp locking pin, wherein the inner portion has at least one aperture for slideably receiving a ramp locking pin, wherein said second end is configured to attach to at least one ramp.

8. The apparatus of claim 7 wherein said loading surface is a tailgate of a vehicle.

9. The apparatus of claim 7 wherein said at least one ramp has at least one set of apertures configured to slideably receive a ramp locking pin.

10. The apparatus of claim 7 wherein said cross support has two plates, wherein said plates are attached to opposite ends of the cross support, wherein each said plate is configured to attach to one locking member.

11. The apparatus of claim 7 wherein said plurality of mounting brackets are adjustable.

12. The apparatus of claim 7 wherein said apparatus is made of metal.

13. The apparatus of claim 12 wherein each of said locking members are attached to at least one said mounting bracket.

14. A method for loading/unloading cargo from a cargo carrier utilizing an apparatus for securing a ramp to a cargo carrier having a receiver hitch and a loading surface, wherein said apparatus comprises (1) an engaging member configured to engage the receiver hitch of the cargo carrier, (2) a cross support attached to said engaging member, wherein said cross support has a plurality of adjustable mounting brackets mounted thereto, (3) at least two locking members, wherein said locking members are mounted to said cross support on opposite sides of said engaging member, said locking members extending vertically from said cross support, wherein each locking member is configured to receive a locking pin, and (4) a plurality of telescopic arms having a first end and a second end, said first end attached to at least one said mounting brackets, wherein each said telescopic arm has an inner portion and an outer portion, wherein each said outer portion has at least one aperture for slideably receiving a locking pin, wherein said inner portion has at least one aperture for slideably receiving a locking pin, wherein said second end is configured to attach to at least one ramp, said method comprising: (a) assembling the apparatus; (b) attaching the engaging member of said apparatus to the receiver hitch of said cargo carrier; (c) attaching at least one ramp to at least two of the plurality of telescopic arms; (d) positioning the top of the at least one ramp to the loading surface of the cargo carrier; and (e) securing at least one locking pin through at least one telescopic arms.

15. The method of claim 14 wherein said loading surface is a tailgate of a vehicle.

16. The method of claim 14 wherein said cross support has two plates, wherein said plates are attached to opposite ends of the cross support, wherein each said plate is configured to attach to one locking member.

17. An apparatus enabling a user to securing a ramp to a cargo carrier, said cargo carrier having a receiver hitch and a loading surface, said ramp having a top end and a bottom end, said apparatus comprising;
an engaging member configured to engage said receiver hitch;
a cross support extending laterally from said engaging member;
a plurality of mounting brackets mounted to said cross support;
a plurality of telescopic arms, each said telescopic arms having a first end and a second end, each said telescopic arm first end pivotally mounted to at least one said mounting brackets, each said telescopic arm second end pivotally mounted between said top end and said bottom end of said ramp, said telescopic arms having an inner portion and an outer portion, said inner portion slideably lockable within said outer portion;
a locking member extending vertically from at least one said mounting brackets, said locking member configured to releasably secure said telescopic arm in a vertical position;
whereby said top end of said ramp is configured to securely engage an edge of said loading surface, whereby said telescopic arms are configured to retain said top end of said ramp against said edge of said loading surface.

18. The apparatus of claim 17, said apparatus further comprises:
a self locking latch attached to at least one said locking member; and
a lock pin attached to at least one said telescopic arm;
whereby said lock pin slideably engages said self locking latch securing said lock pin within said self locking latch.

19. The apparatus of claim 17 wherein said plurality of mounting brackets are slideably attached to said cross support.

20. The apparatus of claim 17, said apparatus further comprises:
a trailer hitch receiver ball.
